(19) United States
(12) Patent Application Publication
(10) Pub. No.: US 2024/0242226 A1
(43) Pub. Date: Jul. 18, 2024

(54) SYSTEM AND METHOD FOR RULE EXTRACTION AND COMPLIANCE ANALYSIS

(71) Applicant: Billd,LLC, Austin, TX (US)

(72) Inventor: Christopher Lee Doyle, Austin, TX (US)

(21) Appl. No.: 18/619,921

(22) Filed: Mar. 28, 2024

Related U.S. Application Data
(63) Continuation-in-part of application No. 17/492,176, filed on Oct. 1, 2021, now abandoned.
(60) Provisional application No. 63/086,242, filed on Oct. 1, 2020.

(51) Int. Cl. G06Q 20/40

(52) U.S. Cl. CPC G06Q 20/405

(57) ABSTRACT

A system parses agreement data (e.g., of an agreement involving a profile) to identify a rule. The system analyzes asset data (e.g., indicative of asset interaction(s)) in comparison with the rule to identify that the profile (e.g., of user(s)) is non-compliant with the agreement at a first time. The system provides, to a device, an interactive user interface for which interaction(s) cause the device to initiate an asset transfer. The system automatically generates field information (e.g., to bring the profile into compliance) based on the asset data and the rule to use to automatically pre-fill field(s) in the interactive user interface. The system updates the asset data based on the asset transfer, and analyzes the updated asset data in comparison with the rule to identify that the profile complies with the agreement at a second time. The system provides, to the device, a notification that indicates compliance with the agreement.

### CROSS-REFERENCE TO RELATED APPLICATIONS

The present patent application is a continuation-in-part of U.S. patent application Ser. No. 17/492,176 filed on Oct. 1, 2021 and titled “System and Method for Utilizing a Mechanic's Lien for Enhancing Payment Performance on an Agreement,” which claims priority benefit of U.S. provisional patent application 63/086,242 filed on Oct. 1, 2020, and titled “Systems and Methods For Utilizing A Mechanic's Lien For Enhancing Payment Performance,” the disclosures of which are incorporated by reference herein in their entireties.

### FIELD

The present disclosure is generally related to a system and method for extracting rules from agreements, analyzing asset data and context data to evaluate compliance with the rules, and providing interactive interfaces for effecting interactions with asset(s) and/or agreement(s) to move from non-compliance with the rules to compliance with the rules.

### BACKGROUND

Agreements, such as financial agreements or other types of agreements, can be complex. It can be difficult, slow, and complex to monitor and track data (e.g., payments, transactions, and the like) and identify whether a user is in compliance with various rules and/or deadlines in an agreement.

### SUMMARY

Systems and methods are disclosed for monitoring data and analyzing compliance. A system parses agreement data to identify a rule. The agreement data is associated with an agreement involving a profile (e.g., of user(s)). The system analyzes asset data in comparison with the rule to identify that the profile is non-compliant with the agreement at a first time. The asset data is indicative of interactions with assets associated with the profile. The system provides an interactive user interface to a computing device associated with the profile. An interaction with the interactive user interface causes the computing device to initiate an asset transfer involving the assets associated with the profile. The system automatically generates field information based on the asset data and the rule. The field information is generated to bring the profile into compliance with the agreement based on the rule. The system automatically pre-fills the field information into a field of the interactive user interface. The system updates the asset data based on the asset transfer to generate updated asset data. The system analyzes the updated asset data in comparison with the rule to identify that the profile complies with the agreement at a second time that is after the first time. The system provides, to the computing device, a notification that indicates that the profile complies with the rule at the second time.

### BRIEF DESCRIPTION OF THE DRAWINGS

FIG. 1 is a block diagram illustrating a system for managing payment performance associated with a financial agreement, in accordance with some examples.

FIG. 2 is a block diagram illustrating a computing device that communicates with a computer that tracks compliance with terms of a financial agreement, in accordance with some examples.

FIG. 3 is a flow diagram illustrating a process for utilizing the mechanic's lien to enhance payment performance on the agreement, in accordance with some examples.

FIG. 4 is a flow diagram illustrating a process performed by a computer that manages compliance with a financial agreement and that issues mechanics liens when stakeholder are not in compliance with their financial agreement, in accordance with some examples.

FIG. 5 is a block diagram illustrating an architecture for an analysis system that analyzes asset data, agreement data, and/or context data to evaluate compliance with one or more agreements, in accordance with some examples.

FIG. 6 is a block diagram illustrating an example of a machine learning (ML) system for training and use of one or more machine learning model(s) used to extract a rule from an agreement and/or to evaluate compliance with the rule of the agreement based on asset data and/or context data, in accordance with some examples.

FIG. 7 is a flow diagram illustrating a process for agreement rule and/or compliance analysis, in accordance with some examples.

### DETAILED DESCRIPTION

Systems and methods are disclosed for monitoring data and analyzing compliance. A system parses agreement data to identify a rule. The agreement data is associated with an agreement involving a profile or account (e.g., of one or more stakeholder(s) and/or other type(s) of user(s)). In some examples, to parse the agreement data to identify the rule, the system interprets text of the agreement to extract the rule from the agreement. In some examples, to parse the agreement data to identify the rule, the system processes the agreement data using a trained machine learning model to generate an output indicative of the rule. In some examples, the system further trains the trained machine learning model based on feedback associated with analyses performed using the rule to update the trained machine learning model for further rule extractions from further agreement data associated with further agreement(s).

The system analyzes asset data in comparison with the rule to identify that the profile or account is non-compliant with the agreement at a first time. The asset data is indicative of interactions with assets associated with the profile or account. In some examples, the system also analyzes context data (e.g., information about a property, person, project, and/or material associated with the profile, account, and/or agreement) to identify that the profile or account is non-compliant with the agreement at the first time. In some examples, to analyze the asset data in comparison with the rule (in some cases also based on the context data), the system processes the asset data, the rule, and/or the context data using a trained machine learning model to generate an output that is indicative of the profile or account being non-compliant with the agreement at the first time. In some examples, the system further trains the trained machine learning model based on feedback associated with the determination of non-compliance of the profile or account with the agreement at the first time, for instance including feedback received via an interactive user interface.

The system provides an interactive user interface to a computing device associated with the profile or account. An interaction with the interactive user interface causes the computing device to initiate an asset transfer involving the assets associated with the profile or account. For instance, the interactive user interface can include an interactive user interface element such as a button or a link, and an interaction with the interactive user interface element (e.g., clicking, tapping, pressing, or otherwise activating the button or link) can cause the interactive user interface to bring up fields for setting aspects of the asset transfer (e.g., asset transfer amounts, account(s) to transfer the asset(s) from, account(s) to transfer the asset(s) to, and the like). The system automatically generates field information based on the asset data and the rule. The field information is generated to bring the profile or account into compliance with the agreement based on the rule. The system automatically pre-fills the field information into a field of the interactive user interface. In some examples, the field information can include an amount of asset(s) to be transferred associated with the asset transfer, account(s) to transfer the asset(s) from, account(s) to transfer the asset(s) to, and the like. In some examples, the system and/or the computing device can initiate the processing of the asset transfer, and/or process the asset transfer. In some examples, processing the asset transfer includes appending the asset transfer to a distributed ledger, for instance by identifying the asset transfer in a payload of a block added to a blockchain ledger or other distributed ledger.

The system updates the asset data based on the asset transfer (e.g., based on the system identifying that the asset transfer has been initiated, processed, and/or completed) to generate updated asset data. The system analyzes the updated asset data in comparison with the rule to identify that the profile or account complies with the agreement at a second time that is after the first time. The system provides, to the computing device, a notification that indicates that the profile or account complies with the rule at the second time. In some examples, the system also analyzes the context data to identify that the profile or account complies with the agreement at the second time. In some examples, to analyze the updated asset data in comparison with the rule (in some cases also based on the context data), the system processes the updated asset data, the rule, and/or the context data using a trained machine learning model to generate an output that is indicative of the profile or account complying with the agreement at the second time. In some examples, the system further trains the trained machine learning model based on feedback associated with the determination of compliance of the profile or account with the agreement at the first time, for instance including feedback received in response to the notification.

The data monitoring and compliance analysis systems and methods discussed herein provide various technical improvements over other systems and methods. For instance, in some examples, the data monitoring and compliance analysis systems and methods discussed herein improve efficiency and accuracy by automating parsing of agreements to identify (e.g., extract) rules from the agreements, where analyzing agreements would otherwise be complex, slow, inefficient, and/or imprecise. In some examples, the data monitoring and compliance analysis systems and methods discussed herein improve efficiency and accuracy by automating analysis of asset data (e.g., payments) in light of the rule(s) of the agreement(s) and/or context data to determine whether a profile or account (e.g., of stakeholder(s)) complies with the agreement(s) or is non-compliant with the agreement(s), where analyzing compliance would otherwise be complex, slow, inefficient, and/or imprecise. In some examples, the data monitoring and compliance analysis systems and methods discussed herein factor in significant amounts of data in compliance decisions, for instance using trained machine learning model(s) to generate outputs indicative of the compliance decisions. In some examples, the data monitoring and compliance analysis systems and methods discussed herein can continue to improve over time, for instance by further training trained machine learning model(s) used for analyzing agreement(s) to identify rule(s) and/or for compliance analyses based on feedback (e.g., feedback on use of the rule(s) and/or on the result(s) of the analyses) to update these trained machine learning model(s) to improve further analyses of further agreement(s) and/or to improve further compliance analyses. In some examples, the data monitoring and compliance analysis systems and methods discussed herein analyze asset data and/or context data dynamically while asset data and/or context data continue to be received. In some examples, the data monitoring and compliance analysis systems and methods discussed herein improve efficiency by providing an interactive user interface that can be interacted with the initiate an asset transfer to bring the profile or account toward (and/or into) compliance, and/or by prefilling certain field(s) of the interactive user interface with field information generated to bring the profile or account toward (and/or into) compliance, improving over complex time-consuming comparisons of asset data, context data, and/or agreement(s) in which mistakes are likely to be made. By handling a number of disparate tasks (e.g., analysis of the agreements, receipt of asset data and/or context data, analysis of compliance with the agreement(s) based on the asset data and/or context data, provision of interactive user interface(s) related to compliance determination, and/or initiation of consequences of non-compliance such as liens), the data monitoring and compliance analysis systems and methods discussed herein reduce network bandwidth usage compared to systems in which certain specific subsets of tasks might be performed by different devices or systems.

In some examples, the system can use a consequence, such as a lien (e.g., a mechanic's lien), to enforce compliance with the agreement. For instance, in some examples, the system can initiating the consequence (e.g., the mechanic's lien) process based on determining that the profile or account (e.g., of the stakeholder(s)) is not in good standing (e.g., not in compliance with terms of the agreement). The system can sending a first notification to the computing device (e.g., of the stakeholder(s)), for instance as part of the interactive user interface. The first notification can indicate non-compliance of the profile or account with the agreement, and in some case can include a notice of intent to lien to the stakeholder based on the determination of non-compliance of the profile or account with the agreement. The system can provide an opportunity to correct the non-compliance through the interactive user interface, for instance allowing the stakeholder to initiate an asset transfer through the interactive user interface to correct the non-compliance, and pre-filling field(s) of the interactive user interface with values that are selected to correct the non-compliance with the agreement, to approach compliance with the agreement, and/or to achieve compliance with the agreement. The system can perform a second determination at the second time to identify whether the profile or account (e.g., of the stakeholder(s)) is in compliance with the agreement (e.g., is in good standing). If the second determination indicates that the profile or account is still non-compliant at the second time, the system may send a lien notification being to the computing device (e.g., of the stakeholder) to initiate the lien process and/or notify the stakeholder that the lien is now in place. If the second determination indicates that the profile or account complies with the agreement at the second time, the system may pause or terminate any lien process that the system may have initiated as a result of the first determination.

In some examples, a system can identify whether a stakeholder is in compliance with terms of a financial agreement. For instance, the system can compare payment due data with payment completed data at a first time to identify whether an agreement (e.g., financial agreement) between an entity and a stakeholder is being adhered to at the first time. In some examples, the system can identify that the agreement has not been adhered to based on the comparison between the payment due data and the payment completed data indicating that the stakeholder has not adhered to a term of the agreement. The system can generate a first notification indicating that a status of an profile or account of the stakeholder is not in good standing to send to a computing device of the stakeholder based on the identification that the financial agreement has not been adhered to. The system sends the first notification to the computing device of the stakeholder to inform the stakeholder that the profile or account of the stakeholder is not in good standing. In some examples, the system can perform an evaluation at a second time (after the first time) to indicate that the stakeholder is still not in good standing at the second time. The system can generate a second notification indicating that a consequence (e.g., a lien, such as a mechanic's lien) will be applied to the stakeholder's profile or account according to the agreement, based on the evaluation indicating that the stakeholder is still not in good standing at the second time. The second notification may them be sent indicating that the consequence (e.g., the lien) will be applied according to the agreement based on the evaluation indicating that the stakeholder is still not in good standing. The system can, in some examples, initiate application of the consequence (e.g., the lien) to the profile or account of the stakeholder. In some examples, the system can identify that the stakeholder has paid an amount above a threshold associated with the agreement (e.g., associated with the payment due data), and can remove or modify the consequence (e.g., the lien) based on the payment of the amount.

In some examples, borrowers borrowing money to purchase a property apply for a loan agreement in one of several ways. For example, a borrower may apply through a lender, or an individual representing the lender or apply electronically. However,

In some cases, a borrower can be notified of violation(s) of payment obligation(s) and warnings of consequences if a payment obligation continues to fail. Further, the lender may report delinquencies to credit bureaus—negatively impacting the borrower's credit score and or, if secured, the lender can pursue foreclosure of the asset. In some cases, the systems and methods discussed herein can use such reporting, but can also pursue other options such as the various notification(s) and interactive interface(s) discussed herein.

In some examples, monitoring deadlines for certain agreements (e.g., for recording the mechanic's liens to commence a legal action to enforce the mechanic's liens against the borrower) can be complex and time-consuming. Further, the time to file the legal action to foreclose upon a mechanic's lien is generally very short, and forgetting or failing to act in this short window of time can result in an unenforceable lien. In addition, the deadlines and statute of limitation deadlines are jurisdictional, resulting in difficulty in recording the deadlines and the statute of limitation. Because the systems and methods discussed herein can automate monitoring of deadlines and acting (e.g., foreclosing upon a mechanic's lien) within such deadlines, the systems and methods discussed herein can reduce or eliminate missed deadlines and provide improved efficiency and flexibility over other techniques.

In some examples, the systems and methods discussed herein can focus on a borrower and/or secured assets, and can enhancing payment performance on an agreement. In some examples, the systems and methods discussed herein can secure enhanced payment performance by recording mechanics' liens. In some examples, a stakeholder can be a real-estate property owner, contractor, sub-contractor, retailer of materials, a stakeholder outside the area of real estate, an owner of any property, or another party.

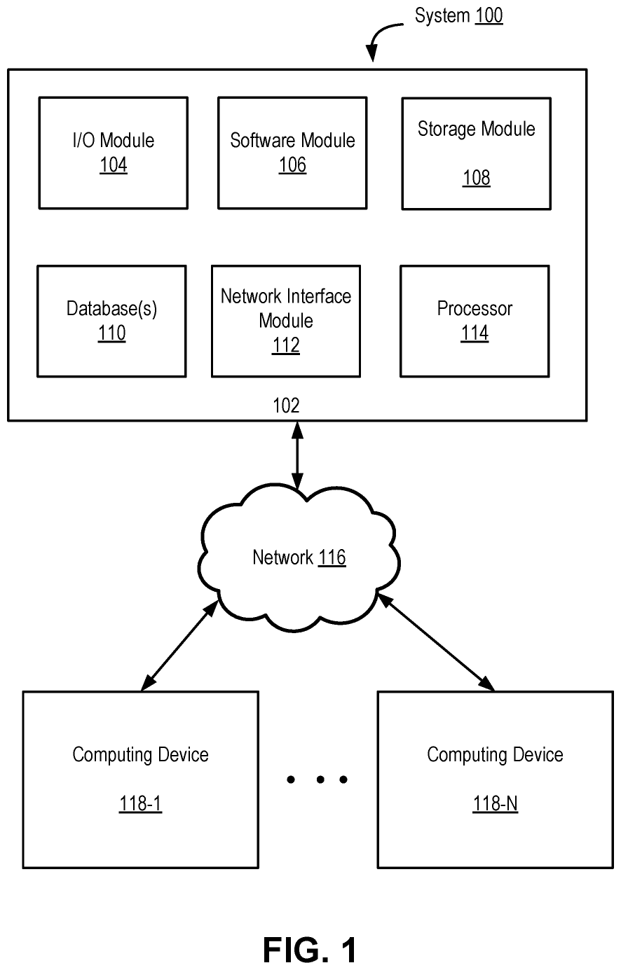

FIG. 1 is a block diagram illustrating a system 100 for managing payment performance associated with a financial agreement. The system 100 for utilizing a mechanic's lien for implementing an enhancement may be fully integrated for use with any additional platform and data output that may be used to communicate with other platforms, such as financial institution platforms, user information platforms, and cyber security and payment collection platforms. The system 100 may comprise a processing system 102. The processing system 102 may be configured to perform a method for enhancing payment performance on the agreement.

The processing system 102 may include an input/output (I/O) module 104, a software module 106, a storage module 108, one or more databases 110, a network interface module 112, and a processor 114. The I/O module 104 may enable a system administrator to provide specialized access of the system 100 to its users. The I/O module 104 may provide access to either input or output or both input and output in the system 100. The users can perform input or output in the system 100 using input or output devices or a user interface of a user device. The input device may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output device may include video displays, graphical displays, speakers, headphones, inkjet printers, laser printers, and 3D printers.

The system 100 for implementing an enhancement may operate as application software that may be managed by a local or remote computing device. The software module 106 is a software component or part of a program that contains one or more routines. Further, the software module 106 may include one or more independently developed modules or set of instructions that enhance a financial instrument. The software module 106 may partition the system design or program or code in whole programs or applications software libraries and classes. In one embodiment, the software module 106 may include a software framework or architecture that optimizes ease of use of at least one existing software platform and may extend the capabilities of at least one existing software platform. The software architecture may approximate the actual way a user organizes and manages electronic files. This may allow a user to organize use activities in a natural, coherent manner while delivering use activities through a simple, consistent, and intuitive interface within each application and across applications. The software architecture may also be reusable, providing plug-in capability to any number of applications without extensive reprogramming, which may enable parties outside of the system 100 to create components that plug into the software architecture. This makes software or portals in the architecture extensible and enables the creation of new software or portals for the architecture by any party.

The software module 106 may also include financial and site planning/progress software applications accessible to the users, such as different users associated with a user or a financial institution to perform one or more functions. The software module 106 in the system 100 may provide the financial and site planning/progress software applications at the same location as the users or a remote location. Each financial and site planning/progress software application may provide a graphical user interface (GUI) for ease of interaction by the users with information resident in the system 100. The GUI may be specific based on the type of user or may be the same for all users or a selected subset of the users.

In addition, the software module 106 may also include a system software to provide a master GUI set that allows the users to select or interact with GUIs of one or more other applications or that allows the users to simultaneously access a variety of information otherwise available through any portion of the system 100. The system software may be a portal or a system as a service (SaaS) that provides, via the GUI, remote access to and from the system 100 for implementing an enhancement. The system software may include, for example, a network browser as well as other standard applications. The system software may also include the ability, either automatically based upon a user request in another application or by a user request, to search or otherwise retrieve data from one or more remote points, such as on the Internet or from a limited or restricted database. The system software may vary by user type or may be available to only a certain user type, depending on the needs of the system 100. The users may have some portions, or all the application software reside on a local computing device, or may simply have linking mechanisms, as understood by those skilled in the art, to link a computing device to the software running on a central server via the communications network, for example. As such, any device having or having access to the system software may be capable of uploading or downloading any information item, data collection item, or informational files associated with such files. Presentation of the data through the software may be in any sort and number of selectable formats. In an exemplary embodiment, a multi-layer format may be used, wherein the additional information is available by viewing successively lower layers of presented information. Such layers may be made available by use of drop-down menus, tabbed folder files, or other layering techniques understood by those skilled in the art or through a novel natural language interface as described herein throughout.

In one embodiment, the storage module 108 may store one or more instructions and data. The data may be related to at least but not limited to agreement between lender and buyer, agreement, lien documents, or agreement security documents. One or more instructions may be instructions that are executable by the processor 114 to perform a specific operation. Some of the commonly known storage implementations may include but are not limited to, fixed (hard) drives, magnetic tape, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g., Microsoft Azure and Amazon Web Services, AWS), or other types of media/machine-readable medium suitable for storing electronic instructions.

In one embodiment, one or more databases 110 may be configured to store a systematic collection of data used for electronic storage and manipulation of data. In one embodiment, the one or more databases 110 may be of various types, such as but not limited to a centralized database, cloud database, and network database. The one or more databases 110 may include structured data containing details of the users, including the lender or the borrower, and all other documents related to their agreement. For example, one or more databases 110 may include the name and address of the lender and borrower, and agreement terms and/or conditions between the lender and the borrower. There are no limitations to the number, type, or connectivity of the one or more databases 110 utilized by the system 100.

The network interface module 112 may perform signal transmission and distribution functions within the system 100. For example, the network interface module 112 may connect electronic devices to electrical systems at the control level. Further, the network interface module 112 may provide many solutions tailored for virtual network deployment and management. For example, the network interface module 112 may efficiently optimize the distribution and management of virtual workloads and provide maximum scalability, reduced bottleneck impediments. Further, the network interface module 112 may be easily integrated into existing hardware and architecture and configured to deploy virtual machine device queues. Further, the network interface module 112 may be ideally suited for the consolidation of virtual network traffic. Processor 114 may be implemented as one or more microprocessors, microcontrollers, digital signal processors, central processing units, logic circuitries, or any devices that can manipulate data based on one or more instructions stored in the storage module 108. In one case, the processor 114 may manipulate data received from one or more databases 110. In another case, the processor 114 may manipulate data stored in the storage module 108.

The system 100 may further comprise a network 116 to enable communication between the processing system 102 and the one or more computing devices 118-1 . . . 118-N. Additionally, the system 100 may utilize any conventional operating platform or combination of platforms (Windows, Mac OS, Unix, Linux, Android, etc.) and may utilize any conventional networking and communications software as would be understood by those skilled in the art. The network 116 can be a wide area network and may be any suitable networked system understood by those having ordinary skill in the art, such as, for example, an open, wide area network (e.g., the Internet), an electronic network, an optical network, a wireless network, a physically secure network or virtual private network, and any combinations thereof. The network 116 may also include any intermediate nodes, such as gateways, routers, bridges, Internet service provider networks, public-switched telephone networks, proxy servers, firewalls, and the like, such that the network may be suitable for the transmission of information items and other data throughout the system 100. The network 116 may also use standard architecture and protocols as understood by those skilled in the art, such as, for example, a packet-switched network for transporting information and packets in accordance with a standard transmission control protocol/Internet protocol (“TCP/IP”).

The system 100 may use an encryption standard to protect data from unauthorized interception over the network 116. The data may be sensitive user financial and personal identification data, government data related to the construction or site plans, other confidential data, and compliance with state and federal laws pertaining to the protection of financial and personal identification data. Further, the system 100 may use any encryption standard or authentication method as may be understood by those having ordinary skill in the art at any point in time. For example, the encryption standard may encrypt an output file using a secure socket layer (SSL) with dual key encryption in an exemplary embodiment. Additionally, the system 100 may limit data manipulation or information access. In an exemplary embodiment, the system administrator may allow for administration of the system at one or more levels, such as at an individual reviewer, a review team manager, a quality control review manager, or a system manager. The system administrator may also implement access or use restrictions for the users at any level. In an exemplary embodiment, the restrictions may include, for example, the assignment of usernames and passwords required for the use of the system 100, run a check for or to implement an enhancement, backend administrative access, associated mobile device apps, or the selection of one or more data types that the user is allowed to view or manipulate.

The one or more computing devices 118-1 . . . 118-N may be coupled to the network 116 and configured to be used by the system administrator, or the users such as contractors, borrowers, and auxiliary users such as but not limited to financial institutions and underwriters. Therefore, it can be noted that one or more computing devices 118-1 . . . 118-N may be referred to as a computing device 118, hereinafter.

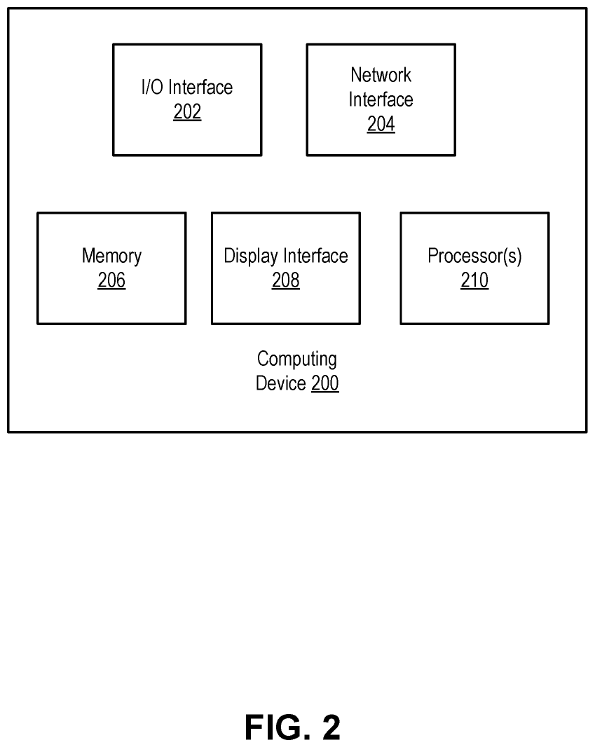

In one embodiment, the computing device 118 may be a central processing server, it may be one server or, more preferably, a combination of scalable servers, providing functionality as a network mainframe server, a web server, a mail server, and central database server, all maintained and managed by the system administrator or operator of the system. Further, the computing device 118 may be connected directly or via a network to remote databases, such as for additional storage backup, to allow communication of files, email, software, and any other data formats between two or more computing devices, such as between a user's mobile device, stakeholder systems, lender systems, and financial institution platforms. It can be noted that the block diagram of the computing device 118 of the system 100 is explained in FIG. 2.

FIG. 2 is a block diagram illustrating of a computing device 200 that communicates with a computer that tracks compliance with terms of a financial agreement. Computing device 200 may be an example of a computing device 118 of FIG. 1. that may be a desktop computer, a mobile device, a laptop, a tablet computer, a smartphone/other wireless digital/cellular phone, or a thin client device as would be understood by those skilled in the art. In an exemplary embodiment, the operable computer components of the system 100 for determining and implementing an enhancement may reside entirely on a single computing device or a central server and run on any number of end-user devices via the network 116. In one exemplary embodiment, the users may run an application or program on their mobile devices so that the system 100 can be easily accessed in real-time at a construction site. In one embodiment, the computing device 118 may include at least one processor, standard input and output devices, as well as all hardware and software for storing data and running programs, and for sending and receiving data over a network 116. For example, the computing device 118 may comprise an input and output (I/O) interface 202, a network interface 204, memory 206, a display interface 208, and at least one processor 210.

A user may use the I/O interface 202 to provide information for utilizing a mechanic's lien for enhancing payment performance on an agreement. The I/O interface 202 may comprise I/O devices, display devices, or a group of devices may be augmented reality devices. The I/O devices may be controlled by an I/O controller. The I/O controller may control one or more I/O devices, such as e.g., a keyboard and a pointing device, e.g., a mouse or optical pen. Furthermore, an I/O device may also allow storage and/or an installation medium for the computing device. In still other embodiments, the computing device 118 may allow USB connections (not shown) to receive handheld USB storage devices. In further embodiments, an I/O device may be a bridge between a system bus and an external communication bus, e.g., a USB bus, a SCSI bus, a FireWire bus, an Ethernet bus, a Gigabit Ethernet bus, a Fiber Channel bus, or a Thunderbolt bus.

The network interface 204 may for ease of interaction by the user with information resident in the system 100 and for facilitating communication of the computing device 118 with the network 116. The network interface 204 may be specific to a user, set of users, or type of user, or may be the same for all users or a selected subset of users. The system software may also provide a master network interface 204 set that allows a user to select or interact with the network interface 204 of one or more other applications, or that allows a user to simultaneously access a variety of information otherwise available through any portion of the system. Further, the network interface 204 may perform signal transmission and distribution functions within the computing device 118.

The memory 206 may be used to store data related to the borrower, the credit history, and the current credit of the borrower or the user. Further, the memory 206 may be configured to store a systematic collection of data used for electronic storage and data manipulation. In one embodiment, the database may be of various types, such as but not limited to a centralized database, cloud database, and network database. The memory 206 may include structured data containing details of the users, including the lender or the borrower, and all other documents related to their agreement. In an embodiment, the memory 206 may include the name and address of the lender and borrower, agreement terms and conditions between the lender and the borrower. There are no limitations to the number, type, or connectivity of the memory 206 utilized by the computing device 118.

The display interface 208 may correspond to output devices including, but not limited to, video displays, graphical displays, speakers, headphones, inkjet printers, laser printers, and 3D printers. In another embodiment, the display interface 208 may correspond to an input/output device like a touch screen, capable of receiving user input. Further, the display interface 208 may be a user device graphical user interface (GUI) or guided user interface(s) that may either accept users' inputs or facilitate outputs to the users or perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may be implemented as a Command Line Interface (CLI), a GUI, a voice interface, or a web-based user interface. For example, the display interface 208 may facilitate users to input data related to credit offers and project information. In one embodiment, the display interface 208 may send notifications in a user-friendly or interactive form to the user.

At least one processor 210 may perform the operations run by the memory 206. In one embodiment, at least one processor 210 may be a digital signal controller (DSC) for processing the signals received during the method of adjusting the credit offer. The DSC may be a hybrid of microcontrollers and digital signal processors (DSPs). In another embodiment, at least one processor 210 may be a microcontroller to process the control signals received during the adjustment of the credit offer. At least one processor 210 may be manufactured by different manufacturers such as Microchip, Freescale, and Texas Instruments.

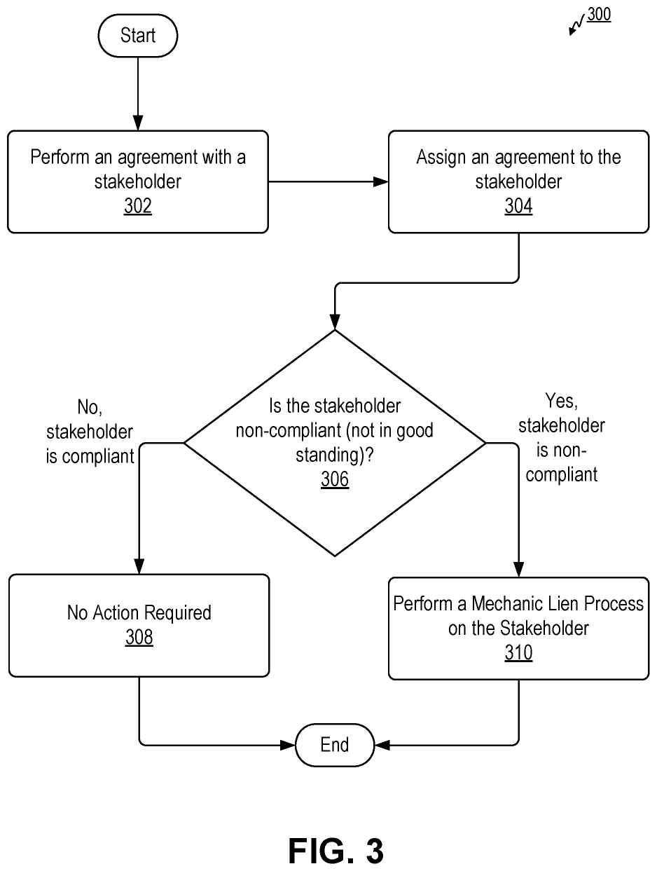

FIG. 3 is a flow diagram illustrating a process 300 for utilizing the mechanic's lien to enhance payment performance on the agreement. It should also be noted that in some alternative implementations, the functions noted in the blocks may occur out of order noted in the drawings. For example, two blocks shown in succession in FIG. 3 maybe executed substantially concurrently, or the blocks may sometimes be executed in the reverse order, depending upon the functionality involved. In addition, the process descriptions or blocks in flow charts should be understood as representing decisions made by a hardware structure such as a state machine. For example, the flowchart of FIG. 3 starts at step 302 and proceeds to step 310.

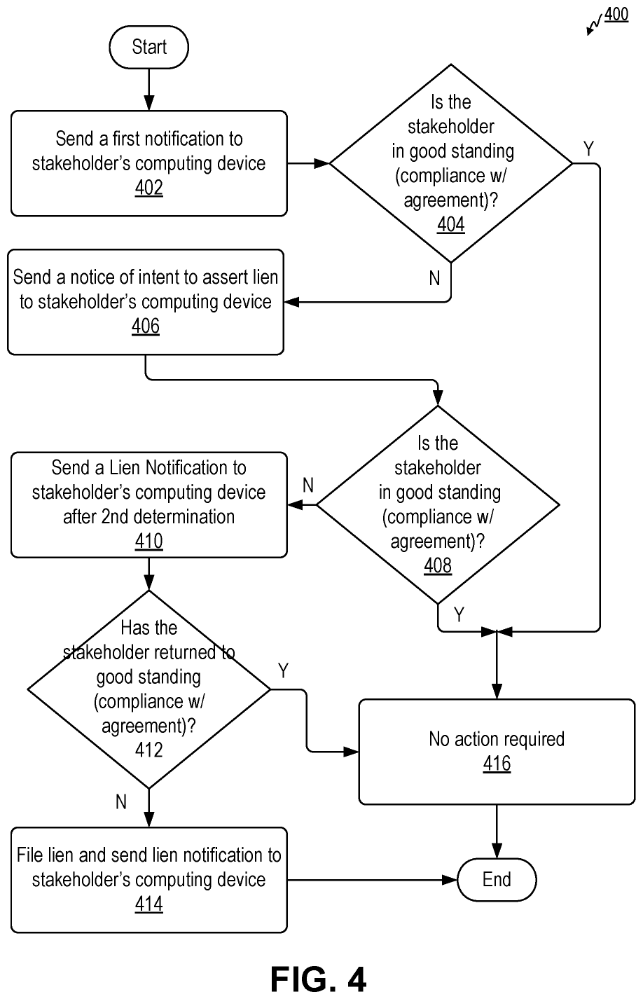

At first, an agreement may be performed with a stakeholder, at step 302. In one exemplary embodiment, a retail installment agreement is made between the lender—Mark, and the borrower—Alex, where Mark is lending a agreement of $10,00,000 to Alex for purchasing construction material on a construction project on 51 Queens Avenue, New York. Successively, an agreement may be assigned to the stakeholder based on the agreement, at step 304. For example, in one exemplary embodiment, Mark provides an agreement of $10,00,000 to Alex based on the retail installment agreement. For example, a “retail installment agreement” or an “agreement” is a contract between two parties whereby money is used to buy materials by a first party and where payments are made by a second party to the first party overtime to pay the first party the total amount plus interest. Successively, a determination may be made as if the stakeholder is not in good standing at step 306. For example, good standing means that any related party payments have been paid for the correct amount and at the correct time. Good standing could also mean a “standing ratio” is met, for instance, the payments that have been made to date are for example greater than 75% of the overall payment. So a payer that has a high standing ratio may be considered in good standing. For example, good standing could also mean meeting a legal deadline. For example, a “legal deadline” is a trigger for filing a lien. For example, a determination is made if Alex has repaid the agreement to Mark. The determination as to whether the stakeholder is not in good standing can be provided, for example, by data made available from an underwriter or a financial institution. In addition, the good standing may disclose whether the stakeholder is in default or delinquent on payments. In one case, when the stakeholder may be in good standing, no action is required at step 308. In one exemplary embodiment, the stakeholder is in good standing if the account has been approved for funding and the stakeholder complies with the retail installment agreement. In one embodiment, when the stakeholder is in good standing, a mechanic lien may still be implemented to maintain and encourage future payment performance. In another case, when the stakeholder may not be in good standing, the mechanic's lien process may be performed on the stakeholder at step 310. In one exemplary embodiment, the stakeholder is not in good standing if the stakeholder is not in compliance with the retail installment agreement (e.g., Alex has not repaid Mark with the agreement of $10,00,000). The mechanic lien process may be explained in conjunction with FIG. 4.

FIG. 4 is a flow diagram illustrating a process 400 performed by a computer that manages compliance with a financial agreement and that issues mechanics liens when stakeholder are not in compliance with their financial agreement. The mechanic lien process of FIG. 4 may start by sending the first notification to the stakeholder at step 402. It can be noted that the first notification may include details such as but not limited to the title of the company or financial institution and agreement detail. In an exemplary embodiment, an email notification is sent to Alex, with details of XYZ company bound to pay Mark an amount of $10,00,000. Successively, if the stakeholder is in good standing, a first determination may be performed at step 404. For example, the system 100 determines if Alex has repaid the agreement of $10,00,000 to Mark.

In one case, when the stakeholder is not in good standing, a notice of intent to lien to the stakeholder may be sent at step 406 based on the first determination. It can be noted that a written notification to the Division that an activity or discharge is intended to be covered by a general permit is sent to the stakeholder. In an exemplary embodiment, if Alex has not repaid the $10,00,000 to Mark, a notice of intent to lien is sent to Alex. Further, if the stakeholder is in good standing, a second determination may be performed at step 408. For example, the system 100 determines if Alex has repaid the agreement of $10,00,000 to Mark. In one case, when the stakeholder is not in good standing, a lien notification may be sent to the stakeholder at step 410 based on the second determination. In an exemplary embodiment, a notice is sent to notify Alex of the consequences of nonpayment, like an added fine of $5000. It can be noted that the lien notification may be a warning that if payment isn't made, the lender intends to file a mechanics lien. Further, if the stakeholder is in good standing, a third determination may be performed at step 412. For example, the system 100 determines if Alex has repaid the agreement of $10,00,000 to Mark. In one case, when the stakeholder is not in good standing, the lien may be filed, and notification to the stakeholder may be sent at step 414, based on the third determination. In an exemplary embodiment, a lien is filed, and a notification is sent to Alex of the consequences of nonpayment, like an added fine of $5000. In another case, when the stakeholder is in good standing, no action may be required at step 416. Further, at steps 404 and 408, no action may be required when the stakeholder is in good standing, and the system 100 moves to step 416 to end the process.

The system and method for utilizing a lien to implement an enhancement may also include standard reporting mechanisms that may enhance payment performance on an agreement by instituting an automatic system for triggering a mechanic's lien process, thereby driving payment on the underlying agreement. The system and method for utilizing a lien to implement an enhancement may also include standard reporting mechanisms, such as generating a printable receipt of the transaction or electronic results report that can be transmitted to any communicatively connected computing device, such as a generated email message or file attachment. Likewise, particular results of the system transaction can trigger an alert signal, such as the generation of an alert email, text, or phone call, to alert a user, financial institution, or person associated with the user or financial institution.

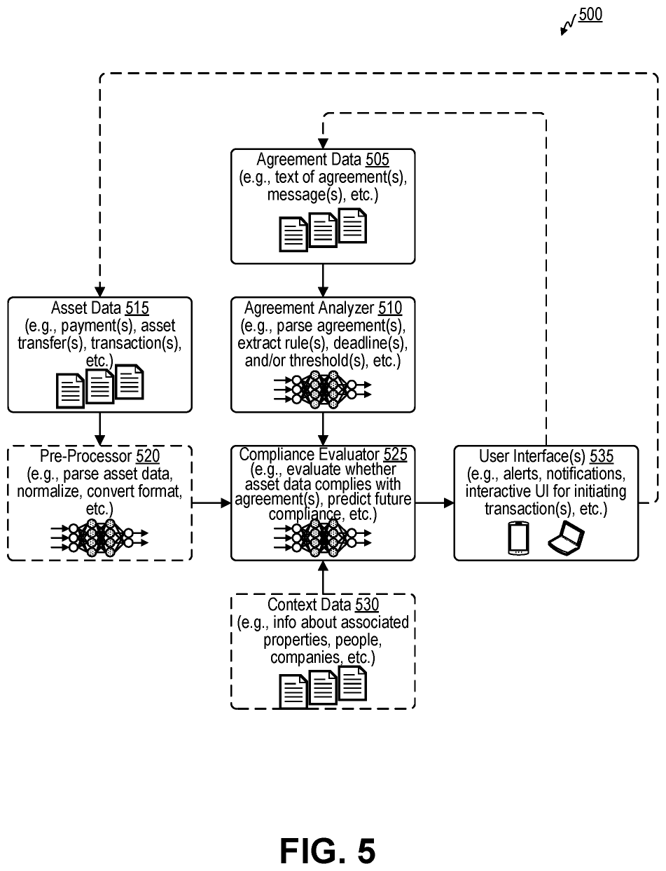

FIG. 5 is a block diagram illustrating an architecture for an analysis system 500 that analyzes asset data 515, agreement data 505, and/or context data 530 to evaluate compliance with one or more agreements. The analysis system 500 can receive the agreement data 505, for instance based on user(s) uploading the agreement data 505 to the analysis system 500 through an interactive user interface (e.g., of the user interface(s) 535). The agreement data 505 includes one or more agreements, for instance in a document format such as a portable document format (PDF), a word processor format (e.g., DOCX, DOC, RTF, TXT), a javascript object notation (JSON) file, a markup format (e.g., HTML, XML, XHTML, markdown), a smart contract stored in a distributed ledger, or a combination thereof. In some examples, the agreement may include contracts, forms, licenses, or other agreements. The analysis system 500 includes an agreement analyzer 510 that parses the agreement data 505 (e.g., parsing and/or interpreting text of the agreement(s)) to identify (e.g., extract) rule(s), deadline(s), and/or threshold(s) from the agreement(s) of the agreement data. For instance, in an illustrative example, an agreement in the agreement data 505 may identify a rule indicating that one or more users (e.g., a stakeholder) is to transfer at least a threshold amount of an asset (e.g., a payment of a fiat currency, a cryptocurrency, or another type of asset) by a specific deadline (e.g., a specific date and/or a specific time) for the one or more users to comply with the agreement. In some examples, the agreement data 505 can include agreement(s) in image form or another form that is not immediately parseable as text. In some examples, the agreement analyzer 510 can perform optical character recognition (OCR) on the file(s) of the agreement in the agreement data 505 to parse the agreement file(s) and identify the text of the agreement. The agreement analyzer 510 can then analyze (e.g., parse and/or interpret) the text of the agreement to identify and/or extract the rule(s) from the agreement. In some examples, the agreement analyzer 510 can convert, format, reformat, rearrange, or otherwise modify the agreement data 505 as part of processing and/or analyzing the agreement data 505 to identify the rule(s). A profile or account can be a party to the agreement(s) in the agreement data 505, for instance as a borrower, lender, or other party. In some examples, the agreement data 505 may include portion(s) of certain agreement(s). In some examples, the agreement data 505 may include certain agreement(s) in their entireties.

In some examples, to analyze the agreement data 505 to identify (e.g., extract) the rule(s) from the agreement data 505, the agreement analyzer 510 can process the agreement data 505 using one or more trained machine learning (ML) model(s), such as the ML model(s) 625 of the ML system 600. The trained ML model(s) can have been trained (e.g., by the agreement analyzer 510) using training data (e.g., training data 660 and/or update(s) 655) that can include, for instance, agreements and corresponding rules (e.g., and/or thresholds and/or deadlines) previously identified and/or extracted from those agreements. In some examples, the agreement analyzer 510 can further train (e.g., retrain, update, and/or fine-tune) the trained ML model(s) based on feedback (e.g., feedback 650) from the compliance evaluator 525 as to how well the identified rule(s) function for the purposes of compliance analysis, based on feedback (e.g., feedback 650) from interactive user interface(s) (e.g., user interface(s) 535), or a combination thereof.

The analysis system 500 receives asset data 515. The asset data 515 can include records, logs, and/or histories of transfers of asset(s), transactions with asset(s), payments of asset(s), balances of account(s) storing assets, or combinations thereof. In some examples, the asset data 515 can be updated over time as new transactions, transfers, and/or payments are performed (e.g., initiated, processed, and/or completed), and/or as balances change. The asset data 515 can include asset transfers, transactions, and/or payments that are transferred and/or paid to comply with the agreement(s) of the agreement data 505 (e.g., or to make progress from non-compliance with the agreement(s) toward compliance with the agreement(s)), for instance including payments from a borrower to a lender to pay off a loan, a lien, a mortgage, or the like. In some examples, the asset data 515 can identify an amount (e.g., a balance) of asset(s) a profile or account of a user has, which the compliance evaluator 525 of the analysis system 500 can use for the purposes of identifying whether the user is capable of transferring enough assets(s) to comply with the agreement or not, for the purposes of pre-filling field(s) in an interactive user interface (e.g., of the user interface(s) 535) with an amount that the user is able to pay, or a combination thereof. In some examples, the analysis system 500 includes a pre-processor 520 that can process the asset data 515, for instance by converting the asset data 515 to a different format, by reformatting the asset data 515, by normalizing the asset data 515 (e.g., e.g., to use a consistent format, to measure values in consistent units, and/or to measure values in consistent currencies or other asset types), or a combination thereof. In some examples, the pre-processor 520 can generate charts, graphs, or other visualizations of the asset data 515. In some examples, the asset data 515 includes spreadsheets, ledgers, databases, records, and/or other types of asset data. In some examples, the asset data 515 is owned by, and/or otherwise associated with, a profile or account.

In some examples, to process the asset data 515, the pre-processor 520 can process the asset data 515 using a trained ML model (e.g., ML model(s) 625). The trained ML model(s) can have been trained (e.g., by the pre-processor 520) using training data (e.g., training data 660 and/or update(s) 655) that can include, for instance, examples of asset data without processing, and examples of the same asset data after processing (e.g., conversions, formatting, and/or normalization). In some examples, the pre-processor 520 can further train (e.g., retrain, update, and/or fine-tune) the trained ML model(s) based on feedback (e.g., feedback 650) from the compliance evaluator 525 as to how well the processed asset data functions for the purposes of compliance analysis, based on feedback (e.g., feedback 650) from interactive user interface(s) (e.g., user interface(s) 535), or a combination thereof.

The analysis system 500 includes a compliance evaluator 525 that analyzes the asset data 515 in comparison with the rule(s) (e.g., threshold(s) and/or deadline(s)) of the agreement(s) in the agreement data 505 to identify whether or not the profile or account complies with the agreement(s). The asset data 515 may be processed using the pre-processor 520 by the time the asset data 515 is analyzed using the compliance evaluator 525. For example, in some cases, the rule(s) of the agreement data 505 may identify a threshold and/or a deadline. In a first illustrative example, the rule(s) of the agreement data 505 may identify a minimum amount of asset transfers (as a threshold) by a specific date (as a deadline). The compliance evaluator 525 can identify that the profile or account of a party is non-compliant with the agreement(s) of the agreement data 505 if a total amount of completed asset transfers by the party is less than the minimum amount of asset transfers (e.g., less than the threshold) by the deadline (e.g., by the date). The compliance evaluator 525 can identify that the profile or account of the party is compliant with (complies with) the agreement(s) of the agreement data 505 if the total amount of completed asset transfers by the party is greater than or equal to the minimum amount of asset transfers (e.g., meeting or exceeding the threshold) by the deadline (e.g., by the date).

In a second illustrative example, the rule(s) of the agreement data 505 may identify a minimum transfer amount of the asset(s) (e.g., a minimum payment amount) (as a threshold) by a specific date (as a deadline). The compliance evaluator 525 can identify that the profile or account of a party is non-compliant with the agreement(s) of the agreement data 505 if a total amount transferred (e.g., paid) by the party is less than the minimum transfer amount (e.g., less than the threshold) by the deadline (e.g., by the date). The compliance evaluator 525 can identify that the profile or account of the party is compliant with (complies with) the agreement(s) of the agreement data 505 if the total amount transferred (e.g., paid) by the party is greater than or equal to the minimum transfer amount (e.g., meeting or exceeding the threshold) by the deadline (e.g., by the date).

In some examples, the compliance evaluator 525 also queries, receives, and/or analyzes context data 530 as part of determining whether the party is compliant or non-compliant with the agreement at a given time. The context data 530 can include information about propertie(s), contractor(s), sub-contractor(s), property owner(s), construction project(s), construction material(s) to use in the construction project(s), project timeline(s) (e.g., for the construction project(s)), a history of previous projects by the contractor(s), a history of previous projects by the sub-contractor(s), a history of previous projects on the property, a history of previous projects involving properties owned by the property owner(s), or a combination thereof. For instance, in some examples, the compliance evaluator 525 can factor aspects into its compliance determination such as trustworthiness, risk, or confidence associated with any of the partie(s) identified with respect to the context data 530, with a project, with previous projects, or a combination thereof. In some examples the profile or account is associated with the property owner(s), the contractor(s), the sub-contractor(s), or a combination thereof. In some examples, the context data 530 are associated with a party (e.g., the same profile or account) that the asset data 515 is from. In some examples, the context data 530 are associated with a party (e.g., the same profile or account) who is a party to the agreement(s) in the agreement data 505. In some examples, the compliance evaluator 525 queries data structure(s) (e.g., database(s), online sources, or other data store(s)) for the context data 530, for instance by using information associated with the party (e.g., a name or an identifier of a profile or account), the asset data 515 (e.g., a specific transaction, asset transfer, or payment), and/or the agreement data 505 (e.g., a specific agreement and/or a related project or property) as a search term, request, or query. In some examples, the compliance evaluator 525 factoring in the context data 530 can be important for accurate compliance analysis because the context data 530 may bring to light circumstances that may affect how the rules of an agreement are implemented or which rule(s) of an agreement applies at a specific time.

In some examples, to analyze the asset data 515 in light of the rule(s) (e.g., identified by the agreement analyzer 510) and/or in light of the context data 530 to evaluate whether the profile or account (of the party) is in compliance with the agreement (e.g., with the rule(s)), the compliance evaluator processes the asset data 515, the rule(s) (e.g., identified by the agreement analyzer 510), the agreement data 505, and/or the context data 530 using one or more trained machine learning (ML) model(s), such as the ML model(s) 625 of the ML system 600. The trained ML model(s) can have been trained (e.g., by the compliance evaluator 525) using training data (e.g., training data 660 and/or update(s) 655) that can include, for instance, asset data, context data, rule(s) of agreement(s) (e.g., with threshold(s) and/or deadline(s)), and determination(s) as to whether a profile or account (e.g., of a party) is in compliance with the agreement(s) (e.g., with the rule(s)) or not based on the asset data and/or context data. In some examples, the compliance evaluator 525 can further train (e.g., retrain, update, and/or fine-tune) the trained ML model(s) based on feedback (e.g., feedback 650) from interactive user interface(s) (e.g., user interface(s) 535), feedback as to the validity of the compliance determination(s), or a combination thereof.

The analysis system 500 can include, and/or can generate and/or provide, various user interface(s) 535 related to the compliance determination(s) from the compliance evaluator 525. The user interface(s) 535 can include notification(s) and/or alert(s) sent to computing device(s) of the party that is determined to be in compliance (or not in compliance) with the agreement(s) (e.g., associated with the agreement data 505) by the compliance evaluator 525. The computing device(s) can output (e.g., display) the alert(s) and/or notification(s)). In some examples, the user interface(s) 535 can include interactive user interface(s) provided to the computing device(s), for instance with interactive user interface element(s) such as buttons, links, sliders, checkboxes, radio buttons, and the like. In some examples, the interactive user interface(s) can allow the party using the computing device(s) to, through interaction(s) with the interactive user interface element(s) of the interactive user interface(s), initiate an asset transfer (e.g., a payment, a transaction). In some examples, the analysis system 500 can generate field information and provide the user interface(s) 535 to the computing device(s) with the field information, so that interactive field(s) in the interactive user interface(s) are pre-filled with the field information when the interactive user interface(s) are accessed via the computing device(s). The field information can be generated by the analysis system 500 (e.g., by the compliance evaluator 525), based on the agreement data 505 (e.g., based on the rule(s)) and/or the asset data 515 (e.g., based on an amount of asset(s) available to the party) and/or the context data 530 (e.g., based on circumstances that may affect how the rules are implemented or which rule applies). In some examples, the field information can be generated by the analysis system 500 (e.g., by the compliance evaluator 525) to progress the profile or account from non-compliance with an agreement toward (and/or to) compliance with the agreement. In some examples, the interaction(s) with the interactive user interface element(s) of the interactive user interface can initiate, process, and/or complete an asset transfer (e.g., payment, transaction) that can update the asset data 515 and trigger a new compliance evaluation of the updated asset data 515 by the compliance evaluator 525. In some examples, the interaction(s) with the interactive user interface element(s) of the interactive user interface can initiate change(s) to agreement(s) and/or rule(s) in the agreement data 505 and trigger a new compliance evaluation of the asset data 515 based on the updated agreement data 505 by the compliance evaluator 525.

In some examples, the compliance evaluator 525 can also generate a prediction as to whether the party (e.g., the profile or account) will continue to comply with the agreement in the future (e.g., at a specific time in the future or until the end of the agreement) or whether the party will become non-compliant with the agreement in the future (e.g., at the specific time in the future or until the end of the agreement). In some examples, the compliance evaluator 525 can generate this prediction based on the agreement data 505, the asset data 515, the context data 530, the rule(s) determined (e.g., by the agreement analyzer 510) from the agreement data 505, previous compliance decisions and/or predictions from the compliance evaluator 525, or a combination thereof. For instance, if the party has continuously complied with the agreement through periodic compliance checks from the beginning, maintains a large amount of assets (e.g., per the asset data 515), the rule(s) (e.g., the thresholds and/or deadlines) of the agreement are not too onerous (e.g., per the agreement data 505), and/or the party has remained compliant with past agreements (e.g., based on context data 530), the compliance evaluator 525 can predict that the party will continue to be compliant with the agreement in the future (e.g., at the specific time in the future or until the end of the agreement). On the other hand, if the party is currently non-compliant with the agreement or has been non-compliant with the agreement in the past, maintains a small amount of assets (e.g., per the asset data 515), the rule(s) (e.g., the thresholds and/or deadlines) of the agreement are particularly onerous (e.g., per the agreement data 505), and/or the party has been non-compliant with past agreements (e.g., based on context data 530), the compliance evaluator 525 can predict that the party will become non-compliant with the agreement in the future (e.g., at the specific time in the future or until the end of the agreement).

In some examples, to generate the prediction as to whether the party (e.g., the profile or account) will continue to comply with the agreement in the future (e.g., at a specific time in the future or until the end of the agreement), the compliance evaluator 525 can process the agreement data 505, the asset data 515, the context data 530, the rule(s) determined (e.g., by the agreement analyzer 510) from the agreement data 505, and/or previous compliance decisions and/or predictions from the compliance evaluator 525 using one or more trained ML model(s), such as the ML model(s) 625 of the ML system 600. The trained ML model(s) can have been trained (e.g., by the compliance evaluator 525) using training data (e.g., training data 660 and/or update(s) 655) that can include, for instance, asset data, context data, rule(s) of agreement(s) (e.g., with threshold(s) and/or deadline(s)), determination(s) as to whether a profile or account (e.g., of a party) is in compliance with the agreement(s) (e.g., with the rule(s)) or not based on the asset data and/or context data, and/or prediction(s) as to whether a profile or account (e.g., of the party) will be in compliance with the agreement(s) (e.g., with the rule(s)) or not. In some examples, the compliance evaluator 525 can further train (e.g., retrain, update, and/or fine-tune) the trained ML model(s) based on observations (e.g., feedback 650) as to whether the profile or account (e.g., of the party) ends up being in compliance or not at the predicted time, based on feedback (e.g., feedback 650) from interactive user interface(s) (e.g., user interface(s) 535), or a combination thereof.

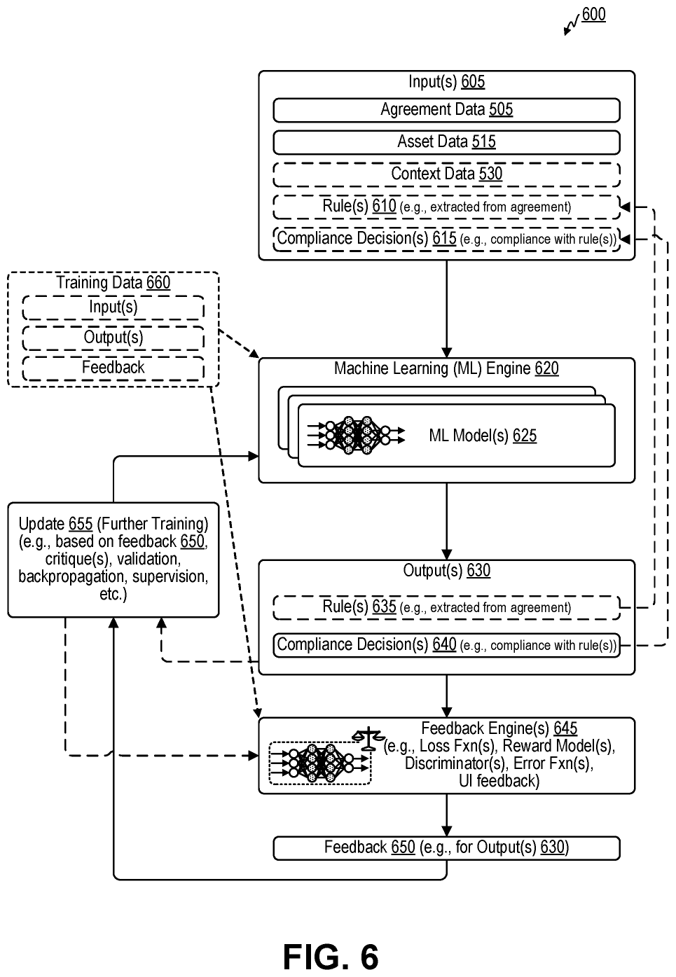

FIG. 6 is a block diagram illustrating an example of a machine learning (ML) system 600 for training and use of one or more machine learning model(s) used to extract a rule from an agreement and/or to evaluate compliance with the rule of the agreement based on asset data and/or context data. The machine learning system 600 a machine learning (ML) engine 620 that generates, trains, uses, and/or updates one or more ML model(s) 625. The ML model(s) 625 can include, for instance, one or more neural network (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with recurrent layer(s), NN(s) with convolutional layer(s), computer vision system(s), deep learning system(s), classifier(s), transformer(s), clustering algorithm(s), reinforcement learning model(s), supervised learning model(s), unsupervised learning model(s), gradient boosting model(s), sequence-to-sequence (Seq2Seq) model(s), autoregressive (AR) model(s), large language model(s) (LLMs), or combinations thereof. Examples of LLMs that can be used can include, for instance, a Generative Pre-Trained Transformer (GPT) (e.g., GPT-2, GPT-3, GPT-3.5, GPT-4, GPT-5, and/or other GPT variant(s)). DaVinci, an LLM using Massachusetts Institute of Technology (MIT) langchain, Google® Bard®, Google® Gemini®, Large Language Model Meta AI (LLaMA), another LLM, or a combination thereof.

Within FIG. 6, a graphic representing the ML model(s) 625 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 625 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 625 can include a feed-forward network, in which case there are no feedback connections where outputs of the network are fed back into itself. In some cases, the ML model(s) 625 can include a recurrent neural network, which can have loops that allow information to be carried across nodes while reading in input. In some cases, the network can include a convolutional neural network, which may not link every node in one layer to every other node in the next layer.

One or more input(s) 605 can be provided to the ML model(s) 625. The ML model(s) 625 can be trained by the ML engine 620 (e.g., based on training data 660) to generate one or more output(s) 630. In some examples, the input(s) 605 include the agreement data 505, the asset data 515, and/or the context data 530.

The output(s) 630 generated by the ML model(s) 625 in response to input of the input(s) 605 (e.g., in response to the agreement data 505, the asset data 515, and/or the context data 530) into the ML model(s) 625 can include one or more rule(s) 635 identified (e.g., extract) from the agreement(s) in the agreement data 505, for instance as discussed with respect to the agreement analyzer 510. In some examples, the rules can include thresholds, ranges, deadlines, or combinations thereof. A first illustrative example of the rule(s) 610 can include, for instance, a minimum asset transfer amount (e.g., a minimum payment amount) threshold to be paid by a specified date (e.g., a deadline). A second illustrative example of the rule(s) 610 can include, for instance, a minimum amount of asset transfers (e.g., a minimum number of payments made) threshold to be paid by a specified date (e.g., a deadline).

In some examples, the rule(s) 635 can be used as input(s) 605 to the ML model(s) 625 (e.g., as one of the rule(s) 610) for generating future rule(s) 635, for generating compliance decision(s) 640, and/or for generating other output(s) 630. In some examples, at least some of the rule(s) 610 in the input(s) 605 represent previously-generated decision(s) that are input into the ML model(s) 625 to generate the rule(s) 635, the compliance decision(s) 640, and/or other output(s) 630. In some examples, based on receipt of the input(s) 605, the ML model(s) 625 can identify the rule(s) 635 at least in part using generative artificial intelligence (AI) content generation techniques, for instance using an LLM to interpret the agreement data 505 and extract and/or summarize the rule(s) therefrom. In some examples, the LLM of the ML model(s) 625 can generate an alert, notification, or user interface element of the user interface(s) 535 that states, in natural language, the rule(s) 610, for instance for user verification (e.g., in the form of feedback 650) as to whether or not the ML model(s) 625 extracted the rule(s) 610 from the agreement data 505 accurately.

The output(s) 630 generated by the ML model(s) 625 in response to input of the input(s) 605 (e.g., in response to the agreement data 505, the asset data 515, the context data 530, and/or the rule(s) 610) into the ML model(s) 625 can include compliance decision(s) 640 indicating whether or not a profile or account associated with a party complies with the agreement(s) (e.g., whether or not the profile or account complies with the rule(s) 610 of the agreement(s)) based on the asset data 515 and/or the context data 530, for instance as discussed with respect to the compliance evaluator 525. The compliance decision(s) 640 include decision(s) that the indicate whether or not the profile or account complies with the agreement(s) in the agreement data 505 (e.g., whether or not the profile or account complies with the rule(s) 610). A first illustrative example of the compliance decision(s) 640 include a decision as to whether or not a total amount of completed asset transfers by the party (e.g., determined based on the asset data 515) exceeds a minimum amount of asset transfers identified in a rule (e.g., of the rule(s) 610) of an agreement (e.g., of the agreement data 505), and therefore complies with the agreement. A second illustrative example of the compliance decision(s) 640 include a decision as to whether or not total transfer (e.g., payment) amount (e.g., determined based on the asset data 515) exceeds a minimum transfer (e.g., payment) amount identified in a rule (e.g., of the rule(s) 610) of an agreement (e.g., of the agreement data 505), and therefore complies with the agreement.

In some examples, the compliance decision(s) 640 can be used as input(s) 605 to the ML model(s) 625 (e.g., as one of the compliance decision(s) 615) for generating future rule(s) 635, for generating future compliance decision(s) 640, and/or for generating other output(s) 630. In some examples, at least some of the compliance decision(s) 615 in the input(s) 605 represent previously-generated compliance decision(s) that are input into the ML model(s) 625 to generate the rule(s) 635, the compliance decision(s) 640, and/or other output(s) 630. In some examples, based on receipt of the input(s) 605, the ML model(s) 625 can generate the compliance decision(s) 640 at least in part using generative artificial intelligence (AI) content generation techniques, for instance using an LLM to generate analyze alignment between the asset data 515 and the agreement data 505 (and in some cases the context data 530), and/or to generate custom text indicative of compliance or non-compliance accordingly. In some examples, the LLM of the ML model(s) 625 can generate an alert, notification, or user interface element of the user interface(s) 535 that states, in natural language, the compliance decision(s) 615 (e.g., indicating whether the party complies with a specified agreement or is non-compliant with the specified agreement).

In some examples, the ML system that includes the ML engine 620 and/or ML model(s) 625 adds the rule(s) 635 and/or the compliance decision(s) 640 to a data store. Data can be drawn from these data store(s) to use as input(s) 605 for the ML model(s) 625 for generating future rule(s) 635, compliance decision(s) 640, and/or other output(s) 630.

In some examples, the ML system repeats the process illustrated in FIG. 6 multiple times to generate the output(s) 630 in multiple passes, using some of the output(s) 630 from earlier passes as some of the input(s) 605 in later passes. For instance, in an illustrative example, in a first pass, the ML model(s) 625 can generate the rule(s) 635 based on input of the agreement data 505, the asset data 515, the context data 530, previous rule(s) 610, and/or previous compliance decision(s) 615 into the ML model(s) 625. In a second pass, the ML model(s) 625 can add (e.g., append) the rule(s) 635 to the input(s) 605 (e.g., to the rule(s) 610), and can generate the compliance decision(s) 640 based on input of the input(s) 605 (e.g., updated to the agreement data 505, the asset data 515, the context data 530, previous rule(s) 610, previous compliance decision(s) 615, and/or the rule(s) 610 generated in the first pass as the rule(s) 635) into the ML model(s) 625. In some examples, the ML model(s) 625 can generate an alert, notification, or other user interface element for the user interface(s) 535, based on input into the ML model(s) 625 of the agreement data 505, the asset data 515, the context data 530, previous rule(s) 610, previous compliance decision(s) 615, the rule(s) 610 generated in the first pass as the rule(s) 635, and/or the compliance decision(s) 615 generated in the second pass as the compliance decision(s) 640.

In some examples, the ML system includes one or more feedback engine(s) 645 that generate and/or provide feedback 650 about the output(s) 630. In some examples, the feedback 650 indicates how well the output(s) 630 align to corresponding expected output(s), how well the output(s) 630 serve their intended purpose, or a combination thereof. In some examples, the feedback engine(s) 645 include loss function(s), reward model(s) (e.g., other ML model(s) that are used to score the output(s) 630), reward function(s), loss model(s), discriminator(s), error function(s) (e.g., in back-propagation), user interface feedback received via user interface(s) 535 from a user, or a combination thereof. In some examples, the feedback 650 can include one or more alignment score(s) that score a level of alignment between the output(s) 630 and the expected output(s) and/or intended purpose.

The ML engine 620 of the ML system can update (further train) the ML model(s) 625 based on the feedback 650 to perform an update 655 (e.g., further training) of the ML model(s) 625 based on the feedback 650. In some examples, the feedback 650 includes positive feedback, for instance indicating that the output(s) 630 closely align with expected output(s) and/or that the output(s) 630 serve their intended purpose. In some examples, the feedback 650 includes negative feedback, for instance indicating a mismatch between the output(s) 630 and the expected output(s), and/or that the output(s) 630 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback. In response to positive feedback in the feedback 650, the ML engine 620 can perform the update 655 to update the ML model(s) 625 to strengthen and/or reinforce weights associated with generation of the output(s) 630 to encourage the ML engine 620 to generate similar output(s) 630 given similar input(s) 605. In response to negative feedback in the feedback 650, the ML engine 620 can perform the update 655 to update the ML model(s) 625 to weaken and/or remove weights associated with generation of the output(s) 630 to discourage the ML engine 620 from generating similar output(s) 630 given similar input(s) 605.

In some examples, the compliance decision(s) 640 can also include, or be based on, predictions as to future compliance by the party with the agreement. In an illustrative example, if the ML model(s) 625 identifies the rule(s) 635 and/or compliance decision(s) 640 indicating that a party complies with a specific agreement of the agreement data 505, and the agreement is ultimately successfully completed, this feedback 650 can be interpreted as positive feedback, strengthening the weights of the ML model(s) 625 that were responsible for generating the rule(s) 635 and/or compliance decision(s) 640 to encourage generation of similar output(s) 630 given similar input(s) 605, and in some cases reinforcing a prediction of continued compliance in the future given similar input(s) 605. On the other hand, if the agreement is ultimately terminated (e.g., due the non-payment or some other failure on the part of a given party), this feedback 650 can be interpreted as negative feedback, weakening the weights of the ML model(s) 625 that were responsible for generating the rule(s) 635 and/or compliance decision(s) 640 to discourage generation of similar output(s) 630 given similar input(s) 605, and in some cases discouraging prediction of continued compliance in the future given similar input(s) 605.

In some examples, the ML engine 620 can also perform an initial training of the ML model(s) 625 before the ML model(s) 625 are used to generate the output(s) 630 based on the input(s) 605. During the initial training, the ML engine 620 can train the ML model(s) 625 based on training data 660. In some examples, the training data 660 includes examples of input(s) (of any input types discussed with respect to the input(s) 605), output(s) (of any output types discussed with respect to the output(s) 630), and/or feedback (of any feedback types discussed with respect to the feedback 650). In an illustrative example, the training data 660 can include agreement data (as in the agreement data 505), asset data (as in the asset data 515), context data (as in the context data 530), rule(s) that correspond to the other input(s) (as in the rule(s) 635 and/or the rule(s) 610), compliance decision(s) that other input(s) (as in the compliance decision(s) 640 and/or the compliance decision(s) 615), and feedback indicating whether the decision(s) are appropriate (e.g., as in the feedback 650).

In some examples, the ML model(s) 625 can generate the output(s) 630 (e.g.. the rule(s) 635 and/or the compliance decision(s) 640) dynamically and in real-time as the input(s) 605 (e.g., the agreement data 505, the asset data 515, the context data 530, the rule(s) 610, and/or the compliance decision(s) 640) continue to be received by the ML model(s) 625. This can ensure that the output(s) 630 (e.g., the rule(s) 635 and/or the compliance decision(s) 640) are generated based on up-to-date input(s) 605.

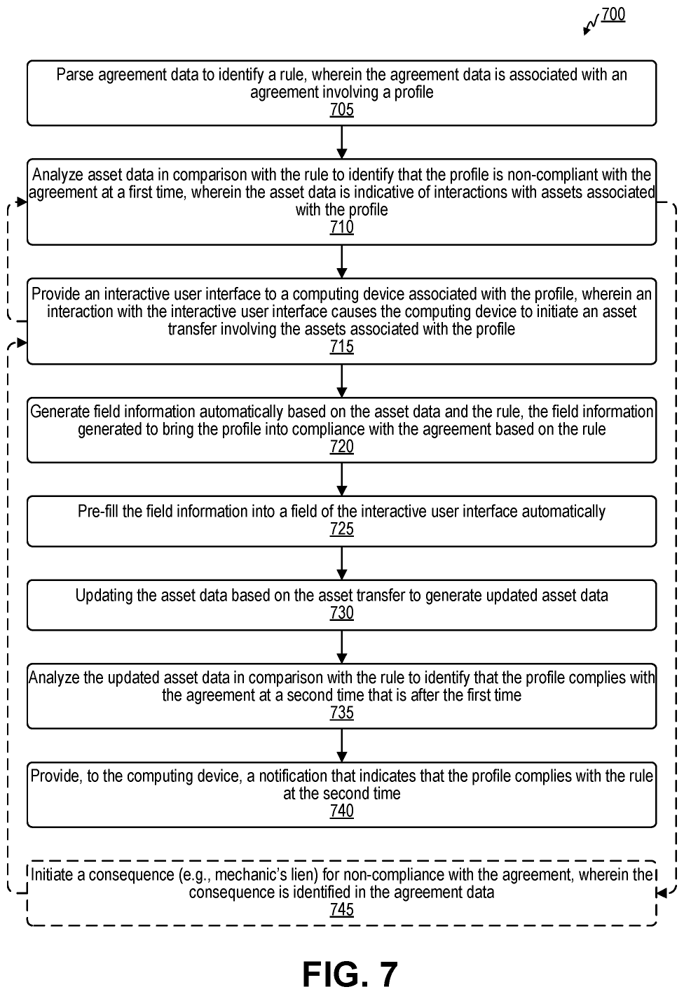

FIG. 7 is a flow diagram illustrating a process 700 for agreement rule and/or compliance analysis. The process 700 may be performed by an analysis system. In some examples, the analysis system can include, for example, the system 100, the network 116, computing device 118-1 through the computing device 118-N, the computing device 200, a system that performs the process 300, a system that performs the process 400, the analysis system 500, the agreement analyzer 510, the pre-processor 520, the compliance evaluator 525, the user interface(s) 535, the ML system 600, the ML engine 620, the ML model(s) 625, the feedback engine(s) 645, and sub-system or component of any of the previously-listed systems, an apparatus, a system, a processor coupled to a memory, a non-transitory computer-readable medium coupled to a processor, or a combination thereof.

At operation 705, the analysis system (or a component or subsystem thereof) is configured to, and can, parse agreement data (e.g., agreement data 505) to identify a rule (e.g., rule(s) 610, rule(s) 635). The agreement data is associated with an agreement involving a profile. The profile may be associated with a party, such as a user or plurality of users (e.g., a company). The profile may be an account. In some examples, operation 705 is performed using the agreement analyzer 510.

In some examples, the analysis system (or a component or subsystem thereof) is configured to, and can, receive the agreement data before parsing the agreement data (in operation 705), for instance over a network and/or from a computing device associated with the profile.

In some examples, parsing the agreement data to identify the rule (as in operation 705) includes interpreting text in the agreement data to extract the rule from text.

In some examples, parsing the agreement data to identify the rule (as in operation 705) includes processing the agreement data using a trained machine learning model to generate an output that is indicative of the rule. In some examples, the trained machine learning model includes a neural network, a CNN, an RNN, a LLM, another type of machine learning model discussed herein, or a combination thereof. In some examples, the analysis system (or a component or subsystem thereof) is configured to, and can, further train the trained machine learning model based on feedback associated with at least one of the analysis of the asset data in comparison with the rule or the analysis of the updated asset data in comparison with the rule, for instance to update the trained machine learning model for further identification of rule(s) from further agreement data.

At operation 710, the analysis system (or a component or subsystem thereof) is configured to, and can, analyze asset data (e.g., asset data 515) in comparison with the rule to identify that the profile is non-compliant with the agreement at a first time. The asset data is indicative of interactions with assets associated with the profile. In some examples, the assets include amounts of fiat currencies, cryptocurrencies, stocks, bonds, non-fungible tokens, and/or other types of assets.

In some examples, the analysis system (or a component or subsystem thereof) is configured to, and can, receive the asset data before analyzing the agreement data (in operation 710), for instance over a network and/or from the computing device associated with the profile.

In some examples, the analysis system (or a component or subsystem thereof) is configured to, and can, process the asset data, for example by converting the asset data to a different format, by reformatting the asset data, by normalizing the asset data (e.g., e.g., to use a consistent format, to measure values in consistent units, and/or to measure values in consistent currencies or other asset types), or a combination thereof. In some examples, the analysis system includes the pre-processor 520, which performs this processing of the asset data.

In some examples, the analysis system includes the compliance evaluator 525, and at least a portion of operation 710 is performed using the compliance evaluator 525.

At operation 715, the analysis system (or a component or subsystem thereof) is configured to, and can, provide an interactive user interface (e.g., user interface(s) 535) to the computing device associated with the profile. An interaction with the interactive user interface (e.g., with an interactive user interface element of the interactive user interface) causes the computing device to initiate an asset transfer involving the assets associated with the profile. In some examples, the interactive user interface element can include a link, a button, a slider, a checkbox, a radio button, another type of user interface element, or a combination thereof. In some examples, the interaction with the interactive user interface (e.g., with the interactive user interface element) connects the computing device to an asset transfer service server (e.g., payment service server), that processes the asset transfer.

In some examples, the profile is associated with at least one of a property owner, a contractor, a sub-contractor, or a combination thereof.

At operation 720, the analysis system (or a component or subsystem thereof) is configured to, and can, generate field information automatically based on the asset data and the rule. The field information is generated to bring the profile toward, and/or into, compliance with the agreement based on the rule. At operation 725, the analysis system (or a component or subsystem thereof) is configured to, and can, pre-fill the field information into a field of the interactive user interface automatically. In some examples, the field information can include information such as a property value, a material price, a lien amount, a loan amount, a project cost, a payment amount (per pay period), a pay period (e.g., weekly payments, monthly payments, yearly payments), a disbursement date, a disbursement amount, a maturity date, a contract value, a revenue amount, a material amount, a labor amount, an overhead amount, a profit amount, a finance charge, an interest amount, a principal amount, a duration of the loan or lien, a selection as to whether to use material purchase financing or not, information from the agreement data, information from the asset data, information from context data 530, information from the rule (e.g., a threshold, a range, a deadline), another type of data discussed herein, or a combination thereof.

In some examples, the analysis system (or a component or subsystem thereof) is configured to, and can, identify a missing asset amount as being a reason for the profile being non-compliant based on the rule and the asset data. The field information can be generated (at operation 720) based on the missing asset amount to cause the profile to change from being non-compliant with the rule to complying with the rule.

At operation 730, the analysis system (or a component or subsystem thereof) is configured to, and can, update the asset data based on the asset transfer (e.g., based on initiation, processing, and/or completion of the asset transfer) to generate updated asset data. In some examples, the analysis system (and/or the computing device associated with the profile) initiates, processes, and/or completes the asset transfer based on the field information pre-filled into the field of the interactive user interface.

At operation 735, the analysis system (or a component or subsystem thereof) is configured to, and can, analyze the updated asset data in comparison with the rule to identify that the profile complies with the agreement at a second time that is after the first time.

In some examples, the analysis system includes the compliance evaluator 525, and at least a portion of operation 735 is performed using the compliance evaluator 525.

At operation 740, the analysis system (or a component or subsystem thereof) is configured to, and can, provide, to the computing device, a notification (e.g., user interface(s) 535) that indicates that the profile complies with the agreement at the second time.

In some examples, the rule includes a threshold. In some examples, analyzing the asset data in comparison with the rule (as in operation 710) includes analyzing the asset data in comparison with the threshold. In some examples, analyzing the updated asset data in comparison with the rule (as in operation 735) includes analyzing the updated asset data in comparison with the threshold.

In some examples, the threshold is a minimum amount of asset transfers. In some examples, the profile is non-compliant with the rule at the first time (as in operation 710) because the asset data indicates that a total amount of completed asset transfers at the first time is less than the minimum amount of asset transfers. In some examples, the profile complies with the agreement at the second time (as in operation 735) because the updated asset data indicates that the total amount of completed asset transfers at the second time is greater than or equal to than the minimum amount of asset transfers.

In some examples, the threshold is a minimum payment amount in association with the agreement. In some examples, the profile is non-compliant with the rule at the first time (as in operation 710) because the asset data indicates that a total amount paid at the first time is less than the minimum payment amount. In some examples, the profile complies with the agreement at the second time (as in operation 735) because the updated asset data indicates that the total amount paid at the second time is greater than or equal to than the minimum payment amount.

In some examples, analyzing the asset data in comparison with the rule (as in operation 710) includes processing the asset data and the rule using a trained machine learning model to generate a first output indicative of the profile being non-compliant with the agreement at the first time. In some examples, analyzing the updated asset data in comparison with the rule (as in operation 735) includes processing the updated asset data and the rule using the trained machine learning model to generate a second output indicative of the profile complying with the agreement at the second time. In some examples, the trained machine learning model includes a neural network, a CNN, an RNN, a LLM, another type of machine learning model discussed herein, or a combination thereof. In some examples, analysis system (or a component or subsystem thereof) is configured to, and can, further train the trained machine learning model based on feedback associated with at least one of the interactive user interface or the notification, for instance to update the trained machine learning model for further compliance decisions based on further asset data and/or further agreement data and/or further context data.

In some examples, the analysis system (or a component or subsystem thereof) is configured to, and can, receive context data (e.g., context data 530) associated with the profile and the agreement. In some examples, the analysis of the asset data in comparison with the rule (as in operation 710) is also based on the context data. In some examples, the analysis of the updated asset data in comparison with the rule (as in operation 735) is also based on the context data. In some examples, the analysis system (or a component or subsystem thereof) is configured to, and can, query a data structure for the context data over a network. In such examples, receiving the context data includes receiving the context data from the data structure over the network. In some examples, the context data includes information about at least one of: propertie(s), contractor(s), sub-contractor(s), property owner(s), construction project(s), construction material(s) to use in the construction project(s), project timeline(s) (e.g., for the construction project(s)), a history of previous projects by the contractor(s), a history of previous projects by the sub-contractor(s), a history of previous projects on the property, a history of previous projects involving properties owned by the property owner(s), or a combination thereof.

In some examples, the analysis system (or a component or subsystem thereof) is configured to, and can, process at least the asset data and the rule using a trained machine learning model to generate a prediction as to whether to expect the profile to be compliant with the agreement at a third time after the second time. In some examples, the third time is the end of the agreement (e.g., all asset(s) due have been paid). In some examples, the third time is a specific amount of time from a current date (e.g., in a specific number of days, weeks, months, year, or a combination thereof). In some examples, the third time is a specific date and/or time. In some examples, the analysis system (or a component or subsystem thereof) is configured to, and can, identify (e.g., observe) whether the profile complies with the agreement at the third time (e.g., after waiting until the third time), and can further train the trained machine learning model based on whether the profile complies with the agreement at the third time (e.g., based on the observation), for instance to update the trained machine learning model for future predictions.

In some examples, following the determination of non-compliance at operation 710, at an operation 745, the analysis system (or a component or subsystem thereof) is configured to, and can, initiate a consequence (e.g., mechanic's lien or other type of lien) for non-compliance with the agreement. In some examples, the consequence is identified in the agreement data.

While various flow diagrams provided and described above may show a particular order of operations performed by certain embodiments of the systems and methods discussed herein, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method of monitoring data and analyzing compliance, the method comprising:
parsing agreement data to identify a rule, wherein the agreement data is associated with an agreement involving a profile;
analyzing asset data in comparison with the rule to identify that the profile is non-compliant with the agreement at a first time, wherein the asset data is indicative of interactions with assets associated with the profile;
providing an interactive user interface to a computing device associated with the profile, wherein an interaction with the interactive user interface causes the computing device to initiate an asset transfer involving the assets associated with the profile;
generating field information automatically based on the asset data and the rule, the field information generated to bring the profile into compliance with the agreement based on the rule;
pre-filling the field information into a field of the interactive user interface automatically;
updating the asset data based on the asset transfer to generate updated asset data;
analyzing the updated asset data in comparison with the rule to identify that the profile complies with the agreement at a second time that is after the first time; and
providing, to the computing device, a notification that indicates that the profile complies with the agreement at the second time.

2. The method of claim 1, wherein parsing the agreement data to identify the rule includes interpreting text in the agreement data to extract the rule from text.

3. The method of claim 1, further comprising:
identifying a missing asset amount as being a reason for the profile being non-compliant based on the rule and the asset data, wherein the field information is generated based on the missing asset amount to cause the profile to change from being non-compliant with the rule to complying with the rule.

4. The method of claim 1, wherein the rule includes a threshold, wherein analyzing the asset data in comparison with the rule includes analyzing the asset data in comparison with the threshold, and wherein analyzing the updated asset data in comparison with the rule includes analyzing the updated asset data in comparison with the threshold.

5. The method of claim 4, wherein the threshold is a minimum amount of asset transfers, wherein the profile is non-compliant with the rule at the first time because the asset data indicates that a total amount of completed asset transfers at the first time is less than the minimum amount of asset transfers, and wherein the profile complies with the agreement at the second time because the updated asset data indicates that the total amount of completed asset transfers at the second time is greater than or equal to than the minimum amount of asset transfers.

6. The method of claim 4, wherein the threshold is a minimum payment amount in association with the agreement, and wherein the profile is non-compliant with the rule at the first time because the asset data indicates that a total amount paid at the first time is less than the minimum payment amount, and wherein the profile complies with the agreement at the second time because the updated asset data indicates that the total amount paid at the second time is greater than or equal to than the minimum payment amount.

7. The method of claim 1, wherein analyzing the asset data in comparison with the rule includes processing the asset data and the rule using a trained machine learning model to generate a first output indicative of the profile being non-compliant with the agreement at the first time, and wherein analyzing the updated asset data in comparison with the rule includes processing the updated asset data and the rule using the trained machine learning model to generate a second output indicative of the profile complying with the agreement at the second time.

8. The method of claim 7, further comprising:
further training the trained machine learning model based on feedback associated with at least one of the interactive user interface or the notification.

9. The method of claim 1, wherein parsing the agreement data to identify the rule includes processing the agreement data using a trained machine learning model to generate an output that is indicative of the rule.

10. The method of claim 9, further comprising:
further training the trained machine learning model based on feedback associated with at least one of the analysis of the asset data in comparison with the rule or the analysis of the updated asset data in comparison with the rule.

11. The method of claim 1, further comprising:
receiving context data associated with the profile and the agreement, wherein the analysis of the asset data in comparison with the rule is also based on the context data, and wherein the analysis of the updated asset data in comparison with the rule is also based on the context data.

12. The method of claim 11, further comprising:
querying a data structure for the context data over a network, wherein receiving the context data includes receiving the context data from the data structure over the network.

13. The method of claim 11, wherein the context data includes information about at least one of a property, a contractor, a sub-contractor, a property owner, a construction project, a construction material, a project timeline, or a history of previous projects.

14. The method of claim 1, further comprising:
processing at least the asset data and the rule using a trained machine learning model to generate a prediction as to whether to expect the profile to be compliant with the agreement at a third time after the second time.

15. The method of claim 14, further comprising:
identifying whether the profile complies with the agreement at the third time; and
further training the trained machine learning model based on whether the profile complies with the agreement at the third time.

16. The method of claim 1, wherein the profile is associated with at least one of a property owner, a contractor, or a sub-contractor.

17. A system that monitors data and analyzes compliance, the system comprising:
a memory that stores instructions; and
a processor that executes the instructions, wherein execution of the instructions by the processor causes the processor to:
parse agreement data to identify a rule, wherein the agreement data is associated with an agreement involving a profile;
analyze asset data in comparison with the rule to identify that the profile is non-compliant with the agreement at a first time, wherein the asset data is indicative of interactions with assets associated with the profile;
provide an interactive user interface to a computing device associated with the profile, wherein an interaction with the interactive user interface causes the computing device to initiate an asset transfer involving the assets associated with the profile;
generate field information automatically based on the asset data and the rule, the field information generated to bring the profile into compliance with the agreement based on the rule;
pre-fill the field information into a field of the interactive user interface automatically;
update the asset data based on the asset transfer to generate updated asset data;
analyze the updated asset data in comparison with the rule to identify that the profile complies with the agreement at a second time that is after the first time; and
provide, to the computing device, a notification that indicates that the profile complies with the agreement at the second time.

18. The system of claim 17, wherein, to analyze the asset data in comparison with the rule, the execution of the instructions by the processor causes the processor to process the asset data and the rule using a trained machine learning model to generate a first output indicative of the profile being non-compliant with the agreement at the first time; and
wherein, to analyze the updated asset data in comparison with the rule, the execution of the instructions by the processor causes the processor to process the updated asset data and the rule using the trained machine learning model to generate a second output indicative of the profile complying with the agreement at the second time.

19. The system of claim 17, wherein, to parse the agreement data to identify the rule, the execution of the instructions by the processor causes the processor to process the agreement data using a trained machine learning model to generate an output that is indicative of the rule.

20. A non-transitory computer readable storage medium having embodied thereon a program, wherein the program is executable by a processor to perform a method of monitoring data and analyzing compliance, the method comprising:
parsing agreement data to identify a rule, wherein the agreement data is associated with an agreement involving a profile;
analyzing asset data in comparison with the rule to identify that the profile is non-compliant with the agreement at a first time, wherein the asset data is indicative of interactions with assets associated with the profile;
providing an interactive user interface to a computing device associated with the profile, wherein an interaction with the interactive user interface causes the computing device to initiate an asset transfer involving the assets associated with the profile;
generating field information automatically based on the asset data and the rule, the field information generated to bring the profile into compliance with the agreement based on the rule;
pre-filling the field information into a field of the interactive user interface automatically;
updating the asset data based on the asset transfer to generate updated asset data;
analyzing the updated asset data in comparison with the rule to identify that the profile complies with the agreement at a second time that is after the first time; and
providing, to the computing device, a notification that indicates that the profile complies with the agreement at the second time.
